(19) United States
(12) Patent Application Publication
(10) Pub. No.: US 2025/0198198 A1
(43) Pub. Date: Jun. 19, 2025

(54) Tool Storage System with an Electric Lock

(71) Applicant: Apex Brands, Inc., Apex, NC (US)

(72) Inventors: Bin Sun, Shanghai (CN); Jingru Wang, Suzhou (CN); Jiangming He, Shanghai (CN); Ming Shuai Wang, Shanghai (CN)

(21) Appl. No.: 18/846,029

(22) PCT Filed: Mar. 15, 2022
(86) PCT No.: PCT/CN2022/080941

§ 371 Date: Sep. 11, 2024

(51) Int. Cl. E05B 47/00; B25H 3/02; E05B 65/462

(52) U.S. Cl. CPC E05B 47/00; B25H 3/02; E05B 65/462; E05B 2047/0056

(57) ABSTRACT

A tool storage system is provided that includes a cabinet, a drawer assembly installed in the cabinet, a lock assembly, and processing circuitry. The drawer assembly includes a drawer operably coupled to the cabinet to enable the drawer to slidably open and close, and a sensor configured to detect a user action to open the drawer. The lock assembly is operably coupled to and between the cabinet and the drawer, and includes an electric lock configured to engage a latch when the drawer is closed, and disengage the latch to enable the drawer to open. The process-ing circuitry operably coupled to the sensor and the electric lock. The processing circuitry is configured to receive a signal from the sensor responsive to detection of the user action to open the drawer, and control the electric lock to disengage the latch responsive to the signal.

### TECHNOLOGICAL FIELD

The present disclosure relates generally to tool storage and, in particular, to a tool storage system including an electric lock.

### BACKGROUND

Tool storage systems are familiar sights from worksites to garages. Tool storage systems take a number of different forms, from utility carts to toolboxes, tool chests, rolling tool cabinets and the like. These tool storage systems allow tools, fasteners and other equipment to be stored in an organized way, and many include drawers for storage. As the drawers of a tool storage system should remain closed when their contents are not being accessed, it is often desirable that the tool storage system include a locking system that secures the drawers in their closed position. Although a number of mechanical locking systems have been developed, it is generally desirably to improve on existing designs.

### BRIEF SUMMARY

Example implementations of the present disclosure are directed to a tool storage system that includes an electric lock for a drawer that keeps the drawer from opening unless a user pulls it open, and that may enable only one drawer from being open at a time. The present disclosure includes, without limitation, the following example implementations.

Some example implementations provide a tool storage system comprising: a cabinet; a drawer assembly installed in the cabinet, the drawer assembly including: a drawer operably coupled to the cabinet to enable the drawer to slidably open and close; and a sensor configured to detect a user action to open the drawer; a lock assembly operably coupled to and between the cabinet and the drawer, the lock assembly including an electric lock and a latch, the electric lock configured to engage the latch when the drawer is closed, and disengage the latch to enable the drawer to open; and processing circuitry operably coupled to the sensor and the electric lock, the processing circuitry configured to receive a signal from the sensor responsive to detection of the user action to open the drawer, and control the electric lock to disengage the latch responsive to the signal.

Some example implementations provide a drawer assembly for a tool storage system that includes a cabinet, the drawer assembly comprising: a drawer operably coupled to the cabinet to enable the drawer to slidably open and close; and a sensor configured to detect a user action to open the drawer when the drawer assembly is installed in the cabinet; and an electric lock or a latch of a lock assembly that includes the electric lock and the lock assembly, the electric lock configured to engage the latch when the drawer assembly is installed in the cabinet and the drawer is closed, and disengage the latch to enable the drawer to open, wherein the sensor and the electric lock are couplable with processing circuitry configured to receive a signal from the sensor responsive to detection of the user action to open the drawer, and control the electric lock to disengage the latch responsive to the signal.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate a tool storage system that may benefit from an electric lock, according to some example implementations of the present disclosure;

FIG. 2 illustrates a tool storage system including an electric lock, according to some example implementations;

FIG. 3A illustrates a drawer assembly for a tool storage system, according to some example implementations; and

FIG. 3B illustrates a cross-section of a portion of the drawer assembly of FIG. 3A, according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

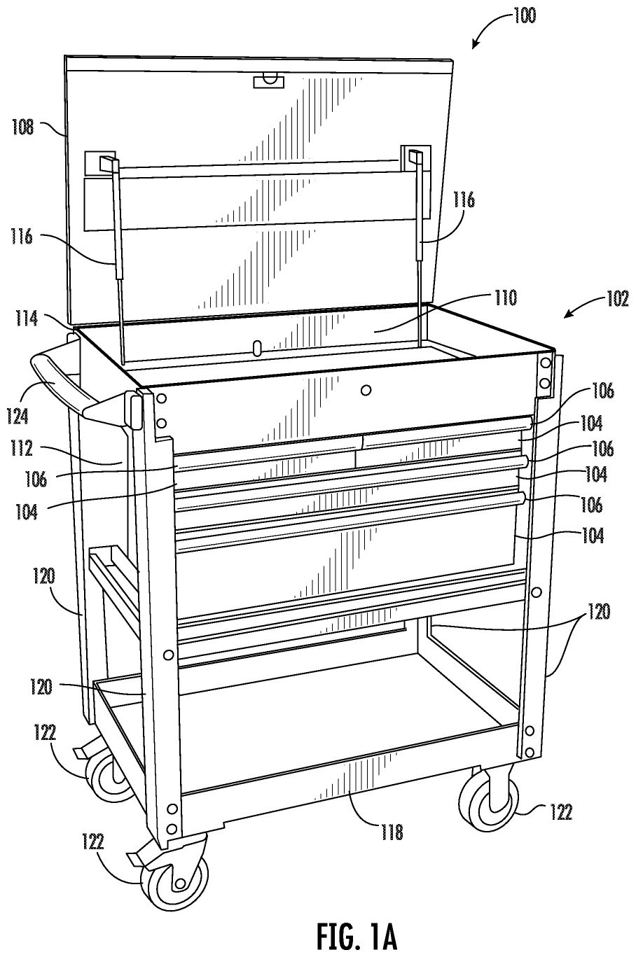

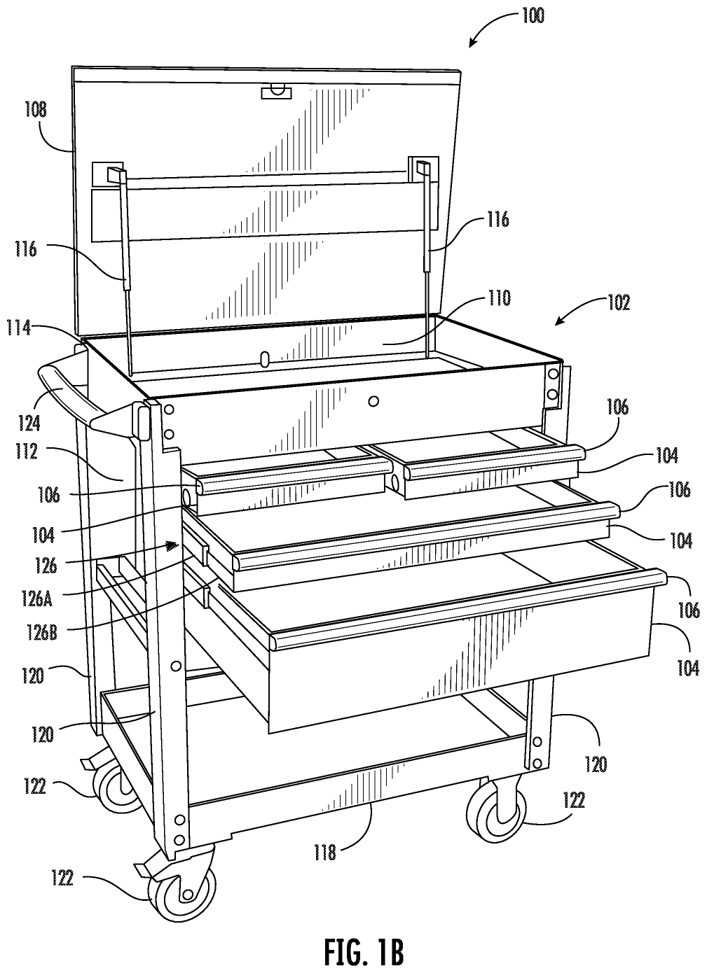

Example implementations of the present disclosure relate generally to tool storage and, in particular, to a tool storage system including an electric lock. FIGS. 1A and 1B illustrate a tool storage system 100 that may benefit from an electric lock, according to some example implementations of the present disclosure. As shown, the tool storage system includes a cabinet 102 with one or more drawers 104 (four drawers shown), and the tool storage system may include drawer handles 106 that allow the drawers to be opened and closed. FIG. 1A illustrates the tool storage system with the drawers closed, and FIG. 1B illustrates the tool storage system with the drawers open. In the illustrated example, the tool storage system is embodied as a utility cart. It should be understood, however, that the tool storage system may be embodied in a number of different manners. In other example implementations, the tool storage system may be embodied as a toolbox, a tool chest, a rolling tool cabinet or the like.

As a utility cart, the tool storage system 100 may include a lid 108 that may be operably coupled to a cabinet back panel 110 (e.g., extending between cabinet side panels 112) via a hinge assembly 114 disposed at the intersection of the cabinet back panel and the lid. In some examples, the tool storage system includes one or more struts 116 to support opening and closing of the lid. The tool storage system may include a bottom tray 118 and posts 120 that support the cabinet 102 above the bottom tray. The tool storage system may include casters 122 or other wheels attached under the bottom tray to enable the tool storage system to be moved, and a side handle 124 may be attached to the cabinet to enable a user to control movement of the tool storage system.

As shown more particularly in FIG. 1B, in some examples, the tool storage system 100 includes drawer slides 126 by which the drawers 104 are operably coupled to the cabinet 102, and that allow the drawers to open and close. The drawer slides may include cabinet members 126A affixed to the cabinet, and drawer members 126B affixed to the drawers, and the drawer members may be slidably engaged with the cabinet members enable the drawer to slidably open and close.

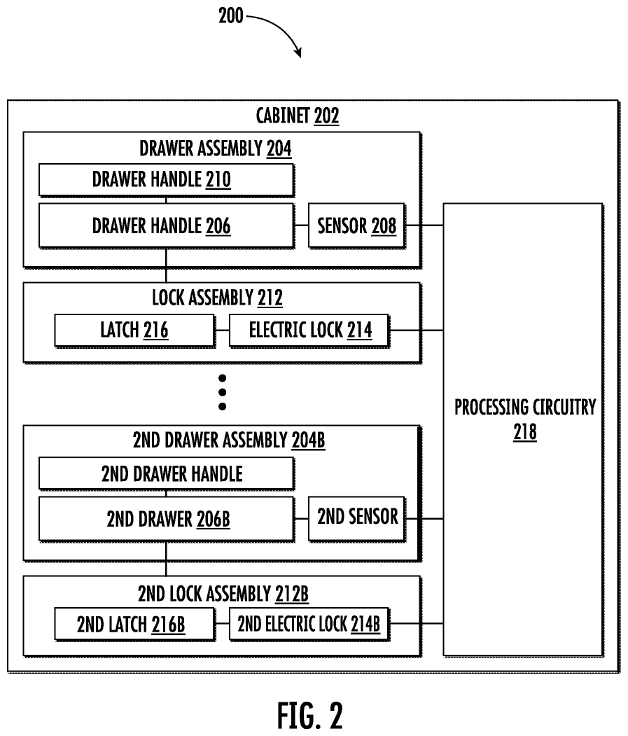

According to example implementations of the present disclosure, a tool storage system such as the tool storage system 100 of FIGS. 1A and 1B includes an electric lock for a drawer 104 that keeps the drawer from opening unless a user pulls it open, and that may enable only one drawer from being open at a time. In this regard, FIG. 2 illustrates a tool storage system 200 including an electric lock, according to some example implementations. In some examples, the tool storage system 200 corresponds to the tool storage system 100 of FIGS. 1A and 1B. Again, in various examples, the tool storage system 200 may be embodied as a utility cart, a toolbox, a tool chest, a rolling tool cabinet or the like.

As shown, the tool storage system 200 includes a cabinet 202 that may correspond to cabinet 102. The tool storage system includes a drawer assembly 204 installed in the cabinet. The drawer assembly includes a drawer 206 and a sensor 208; and in some examples, the drawer assembly includes a drawer handle 210 that is a component part of the drawer, or that is affixed to the drawer. The drawer may correspond to drawer 104, and the drawer handle may correspond to drawer handle 106. The drawer is operably coupled to the cabinet to enable the drawer to slidably open and close, and the sensor is configured to detect a user action to open the drawer. Examples of suitable sensors include an optical sensor, pressure sensor, touch sensor or electric switch configured to detect the user action to open the drawer.

In some examples, the sensor 208 configured to detect the user action includes the sensor configured to detect a pulling force applied to the drawer 206. In some further examples, the drawer assembly 204 further includes a drawer handle 210 that is movably affixed to the drawer, and the sensor includes an electric switch. And in some of these further examples, the drawer handle is movable into contact with the electric switch responsive to the pulling force applied to the drawer handle, and the electric switch is thereby configured to detect the pulling force.

The tool storage system 200 includes a lock assembly 212 operably coupled to and between the cabinet 202 and the drawer 206. The lock assembly includes an electric lock 214 and a latch 216. The electric lock is configured to engage the latch when the drawer is closed, and disengage the latch to enable the drawer to open. In some examples, the electric lock is affixed to the cabinet, and the latch is affixed to the drawer. In other examples, the electric lock is affixed to the drawer, and the latch is affixed to the cabinet.

In various examples, the tool storage system 200 further includes processing circuitry 218, which may be installed in the cabinet 202 in any of a number of different manners. The processing circuitry is operably coupled to the sensor 208 and the electric lock 214. In this regard, the processing circuitry is configured to receive a signal from the sensor responsive to detection of the user action to open the drawer 206, and control the electric lock to disengage the latch 216 responsive to the signal.

As explained above, the lock assembly 212 including the electric lock 214 may keep the drawer 206 from opening unless a user pulls it open. In some examples, the lock assembly may also be used to enable only one drawer from being open at a time. In this regard, for a tool storage system 200 with multiple drawers, some if not all of the drawers may be provided with respective drawer assemblies 204 and lock assemblies. The tool storage system, then, may include a second drawer assembly 204B with a second drawer 206B that is operably coupled to the cabinet 202; and the second drawer assembly may be operably coupled to a second lock assembly 212B. This drawer assembly may be constructed in a manner that is the same as or similar to the drawer assembly, and the second lock assembly may be constructed in a manner that is the same as or similar to the lock assembly. In some of these examples, the processing circuitry 218 may be configured to control the electric lock to disengage the latch 216 only when the second drawer is closed.

In particular, for example, the processing circuitry 218 may receive the signal from the sensor 208, responsive to detection of a user action to open the drawer 206. The processing circuitry may determine an open-closed position of the second drawer 206B, and control the electric lock 214 to disengage the latch 216 only when the second drawer is in the closed position. The open-closed position of the second drawer may be determined in a number of different manners, such as by tracking when a second latch 216B of the second drawer assembly 204B is engaged with and disengaged from a respective second electric lock 214B.

Likewise, in various examples, the processing circuitry 218 may control the electric lock 214 to disengage the latch 216, responsive to a number of circumstances or conditions. The processing circuitry may be configured to receive user input, and disengage the latch in response. In some of these examples, the user input may be received through a user input interface installed on the tool storage system 200. In other examples, the processing circuitry may be operatively coupled with a computer such as a smartphone or tablet that may provide a user input interface by which user input may be received and communicated to the processing circuitry by a wired or wireless connection between the computer and the processing circuitry.

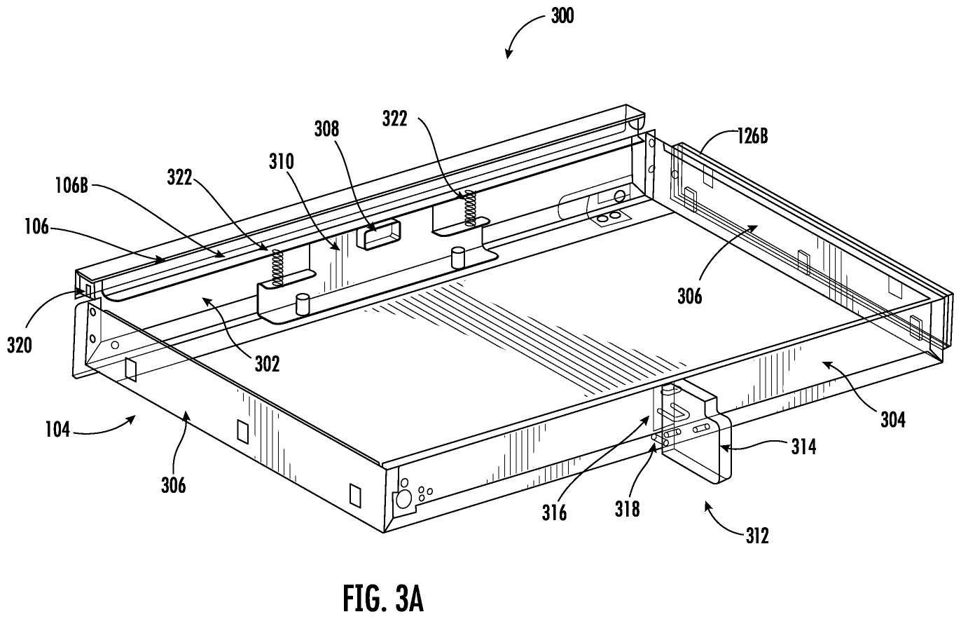

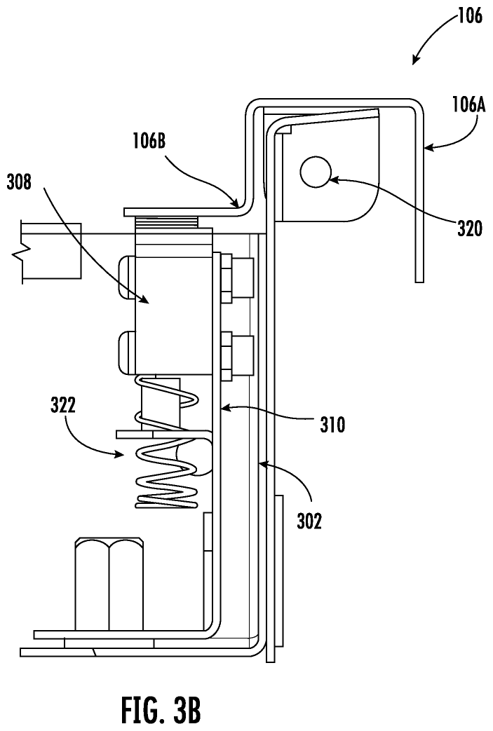

FIG. 3A illustrates a more particular implementation of a drawer assembly 300 that may correspond to drawer assembly 204, and that may be installed in the cabinet 102 of the tool storage system 100, and FIG. 3B illustrates a cross-section of a portion of the drawer assembly, according to some example implementations. As shown, the drawer assembly includes a drawer 104 that may correspond to drawer 206, and that may be operably coupled to the cabinet to enable the drawer to slidably open and close. Also shown is a drawer handle 106 that may correspond to drawer handle 210, and that may be affixed to the drawer.

As shown more particularly in FIG. 3A, the drawer 104 may include a drawer front panel 302 to which the drawer handle 106 may be affixed. The drawer may also include a drawer back panel 304, and drawer side panels 306. In some examples in which the tool storage system 100 includes drawer slides 126, the drawer side panels may be operably coupled to the cabinet side panels 112 by the drawer slides, and the drawer may thereby be operably couple to the cabinet 102. More particularly, the cabinet members 126A of the drawer slides may be affixed to respective ones of the cabinet side panels, and the drawer members 126B may be affixed to respective ones of the drawer side panels. The drawer members, then, may be slidably engaged with the cabinet members enable the drawer to slidably open and close.

According to some example implementations of the present disclosure, the drawer assembly 300 includes a sensor such as an electric switch 308 (e.g., sensor 208). In some examples, the drawer assembly further includes a stand 310 by which the electric switch may be affixed to the drawer 104.

The drawer assembly 300 may also include a component part of a lock assembly 312 that may correspond to lock assembly 212. The lock assembly may include an electric lock 314 and latch 316, which may correspond to respectively electric lock 214 and latch 216. As shown, the latch is affixed to the drawer, and the latch may engage the electric lock that is affixed to the cabinet 102. In other examples, the electric lock is affixed to the drawer, and the electric lock may engage the latch that is affixed to the cabinet. The electric lock or latch may be affixed to the drawer 104 in a number of different manners. In some examples, the electric lock/latch may be affixed to the drawer back panel 304, and configured to engage the latch/electric lock that is affixed to the cabinet back panel 110 (inside the cabinet).

As explained above, processing circuitry such as processing circuitry 218 may be operably coupled to the electric switch 308 and the electric lock 314. The processing circuitry may be configured to receive a signal from the sensor responsive to detection of a user action to open the drawer 104, and control the electric lock to disengage the latch 316 responsive to the signal. In particular, in some examples, the drawer handle 106 is movable into contact with the electric switch responsive to a pulling force applied to the drawer handle. The electric switch is configured to send a signal to the processing circuitry responsive to the contact and thereby the pulling force. And the processing circuitry is configured to control the electric lock to disengage the latch responsive to the signal. In this manner, the drawer assembly 300 with the electric lock may that keep the drawer 104 from opening unless a user pulls it open by application of a pulling force on the drawer handle.

In some examples, the electric lock 314 includes a spring-loaded pin 318 that is compressed inside the electric lock when the electric lock is engaged with the latch 316. In these examples, the spring-loaded pin may be configured to extend out from the electric lock when the latch is disengaged to push the drawer at least partially open.

As shown in FIG. 3A, and more particularly in FIG. 3B, in some examples, the drawer assembly 300 further includes a rotatable shaft 320 by which the drawer handle is movably affixed to the drawer 104. In these examples, the drawer handle is rotatable and thereby movable into contact with the electric switch 308 responsive to the pulling force applied to the drawer handle 106. In some other examples, the drawer assembly further includes a linearly movable shaft by which the drawer handle is movably affixed to the drawer. In these other examples, and the drawer handle is movable forward and backward and thereby movable into contact with the electric switch responsive to the pulling force applied to the drawer handle.

The drawer handle 106 as shown includes a pull member 106A and a contact member 106B that are connected and movable (e.g., rotatable) together responsive to the pulling force that is applied to the pull member, and the contact member is movable into contact with the electric switch. The pull member and the contact member may be located on opposing sides of the drawer front panel 302, with the pull member located outside the drawer 104, and the contact member located inside the drawer. The stand 310 and thereby the electric switch 308, then, may also located inside the drawer to enable the contact member of the drawer handle to move into contact with the electric switch. In some further examples, the drawer assembly includes at least one spring 322 affixed to and between the contact member and the stand. The at least one spring is configured to bias the contact member out of contact with the electric switch that is affixed to the stand, and compress as the contact member is moved into contact with the electric switch.

The processing circuitry 302 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

As explained above and reiterated below, the present disclosure includes, without limitation, the following example implementations.

Clause 1. A tool storage system comprising: a cabinet; a drawer assembly installed in the cabinet, the drawer assembly including: a drawer operably coupled to the cabinet to enable the drawer to slidably open and close; a sensor configured to detect a user action to open the drawer; a lock assembly operably coupled to and between the cabinet and the drawer, the lock assembly including an electric lock and a latch, the electric lock configured to engage the latch when the drawer is closed, and disengage the latch to enable the drawer to open; and processing circuitry operably coupled to the sensor and the electric lock, the processing circuitry configured to receive a signal from the sensor responsive to detection of the user action to open the drawer, and control the electric lock to disengage the latch responsive to the signal.

Clause 2. The tool storage system of clause 1, wherein the electric lock is affixed to the cabinet, and the latch is affixed to the drawer.

Clause 3. The tool storage system of clause 2, wherein the cabinet includes a cabinet back panel, and the drawer includes a drawer back panel, and wherein the electric lock is affixed to the cabinet back panel, and the electric lock is configured to engage the latch that is affixed to the drawer back panel.

Clause 4. The tool storage system of any of clauses 1 to 3, wherein the electric lock is affixed to the drawer, and the latch is affixed to the cabinet.

Clause 5. The tool storage system of clause 4, wherein the cabinet includes a cabinet back panel, and the drawer includes a drawer back panel, and wherein the electric lock is affixed to the drawer back panel, and the electric lock is configured to engage the latch that is affixed to the cabinet back panel.

Clause 6. The tool storage system of any of clauses 1 to 5, wherein the cabinet includes cabinet side panels, and the drawer includes drawer side panels, and wherein the tool storage system further comprises drawer slides by which the drawer side panels are operably coupled to the cabinet side panels, and by which the drawer is thereby operably coupled to the cabinet.

Clause 7. The tool storage system of clause 6, wherein the drawer slides include cabinet members affixed to respective ones of the cabinet side panels, and drawer members affixed to respective ones of the drawer side panels, the drawer members slidably engaged with the cabinet members enable the drawer to slidably open and close.

Clause 8. The tool storage system of any of clauses 1 to 7, wherein the sensor includes an optical sensor, pressure sensor, touch sensor or electric switch configured to detect the user action to open the drawer.

Clause 9. The tool storage system of any of clauses 1 to 8, wherein the drawer assembly further includes a drawer handle that allows the drawer to be opened and closed.

Clause 10. The tool storage system of any of clauses 1 to 9, wherein the sensor configured to detect the user action includes the sensor configured to detect a pulling force applied to the drawer.

Clause 11. The tool storage system of clause 10, wherein the drawer assembly further includes a drawer handle movably affixed to the drawer, and the sensor includes an electric switch, and wherein the drawer handle is movable into contact with the electric switch responsive to the pulling force applied to the drawer handle, and the electric switch is thereby configured to detect the pulling force.

Clause 12. The tool storage system of clause 11, the drawer assembly further includes a rotatable shaft by which the drawer handle is movably affixed to the drawer, and the drawer handle is rotatable and thereby movable into contact with the electric switch responsive to the pulling force applied to the drawer handle.

Clause 13. The tool storage system of clause 11 or clause 12, wherein the drawer assembly further includes a linearly movable shaft by which the drawer handle is movably affixed to the drawer, and the drawer handle is movable forward and backward and thereby movable into contact with the electric switch responsive to the pulling force applied to the drawer handle.

Clause 14. The tool storage system of any of clauses 11 to 13, wherein the drawer handle includes a pull member and a contact member that are connected and movable together responsive to the pulling force that is applied to the pull member, and the contact member is movable into contact with the electric switch, and wherein the drawer includes a drawer front panel by which the drawer handle is movably affixed to the drawer, the pull member and the contact member are located on opposing sides of the drawer front panel, the pull member located outside the drawer, and the contact member is located inside the drawer.

Clause 15. The tool storage system of clause 14, wherein the drawer assembly further includes a stand by which the electric switch is affixed to the drawer, and wherein the stand and thereby the electric switch are located inside the drawer to enable the contact member of the drawer handle to move into contact with the electric switch.

Clause 16. The tool storage system of clause 15, wherein the drawer assembly further includes at least one spring affixed to and between the contact member of the drawer and the stand, the at least one spring configured to bias the contact member out of contact with the electric switch that is affixed to the stand, and compress as the contact member is moved into contact with the electric switch.

Clause 17. The tool storage system of any of clauses 1 to 16, wherein the electric lock includes a spring-loaded pin that is compressed inside the electric lock when the electric lock is engaged with the latch, and configured to extend out from the electric lock when the latch is disengaged to push the drawer at least partially open.

Clause 18. The tool storage system of any of clauses 1 to 17, wherein the tool storage system further comprises a second drawer that is operably coupled to the cabinet, and the processing circuitry is configured to control the electric lock to disengage the latch only when the second drawer is closed.

Clause 19. A drawer assembly for a tool storage system that includes a cabinet, the drawer assembly comprising: a drawer operably coupled to the cabinet to enable the drawer to slidably open and close; a sensor configured to detect a user action to open the drawer when the drawer assembly is installed in the cabinet; and an electric lock or a latch of a lock assembly that includes the electric lock and the lock assembly, the electric lock configured to engage the latch when the drawer assembly is installed in the cabinet and the drawer is closed, and disengage the latch to enable the drawer to open, wherein the sensor and the electric lock are couplable with processing circuitry configured to receive a signal from the sensor responsive to detection of the user action to open the drawer, and control the electric lock to disengage the latch responsive to the signal.

Clause 20. The drawer assembly of clause 19, wherein the drawer assembly includes the latch that is affixed to the drawer.

Clause 21. The drawer assembly of clause 20, wherein the cabinet includes a cabinet back panel, and the drawer includes a drawer back panel, and wherein the latch affixed to the drawer back panel, and the latch is configured to engage the electric lock that is affixed to the cabinet back panel.

Clause 22. The drawer assembly of any of clauses 19 to 21, wherein the drawer assembly includes the electric lock that is affixed to the drawer.

Clause 23. The drawer assembly of clause 22, wherein the cabinet includes a cabinet back panel, and the drawer includes a drawer back panel, and wherein the electric lock is affixed to the drawer back panel, and the electric lock is configured to engage the latch that is affixed to the cabinet back panel.

Clause 24. The drawer assembly of any of clauses 19 to 23, wherein the sensor includes an optical sensor, pressure sensor, touch sensor or electric switch configured to detect the user action to open the drawer.

Clause 25. The drawer assembly of any of clauses 19 to 24, wherein the

drawer assembly further includes a drawer handle that allows the drawer to be opened and closed.

Clause 26. The drawer assembly of any of clauses 19 to 25, wherein the sensor configured to detect the user action includes the sensor configured to detect a pulling force applied to the drawer.

Clause 27. The drawer assembly of clause 26, wherein the drawer assembly further includes a drawer handle movably affixed to the drawer, and the sensor includes an electric switch, and wherein the drawer handle is movable into contact with the electric switch responsive to the pulling force applied to the drawer handle, and the electric switch is thereby configured to detect the pulling force.

Clause 28. The drawer assembly of clause 27, the drawer assembly further includes a rotatable shaft by which the drawer handle is movably affixed to the drawer, and the drawer handle is rotatable and thereby movable into contact with the electric switch responsive to the pulling force applied to the drawer handle.

Clause 29. The drawer assembly of clause 27 or clause 28, wherein the drawer assembly further includes a linearly movable shaft by which the drawer handle is movably affixed to the drawer, and the drawer handle is movable forward and backward and thereby movable into contact with the electric switch responsive to the pulling force applied to the drawer handle.

Clause 30. The drawer assembly of any of clauses 27 to 29, wherein the drawer handle includes a pull member and a contact member that are connected and movable together responsive to the pulling force that is applied to the pull member, and the contact member is movable into contact with the electric switch, and wherein the drawer includes a drawer front panel by which the drawer handle is movably affixed to the drawer, the pull member and the contact member are located on opposing sides of the drawer front panel, the pull member located outside the drawer, and the contact member is located inside the drawer.

Clause 31. The drawer assembly of clause 30, wherein the drawer assembly further includes a stand by which the electric switch is affixed to the drawer, and wherein the stand and thereby the electric switch are located inside the drawer to enable the contact member of the drawer handle to move into contact with the electric switch.

Clause 32. The drawer assembly of clause 31, wherein the drawer assembly further includes at least one spring affixed to and between the contact member of the drawer and the stand, the at least one spring configured to bias the contact member out of contact with the electric switch that is affixed to the stand, and compress as the contact member is moved into contact with the electric switch.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A tool storage system comprising:
a cabinet;
a drawer assembly installed in the cabinet, the drawer assembly including:
a drawer operably coupled to the cabinet to enable the drawer to slidably open and close; and
a sensor configured to detect a user action to open the drawer;
a lock assembly operably coupled to and between the cabinet and the drawer, the lock assembly including an electric lock and a latch, the electric lock configured to engage the latch when the drawer is closed, and disengage the latch to enable the drawer to open; and
processing circuitry operably coupled to the sensor and the electric lock, the processing circuitry configured to receive a signal from the sensor responsive to detection of the user action to open the drawer, and control the electric lock to disengage the latch responsive to the signal.

2. The tool storage system of claim 1, wherein the electric lock is affixed to the cabinet, and the latch is affixed to the drawer.

3. The tool storage system of claim 1, wherein the electric lock is affixed to the drawer, and the latch is affixed to the cabinet.

4. The tool storage system of claim 1, wherein the sensor includes an optical sensor, pressure sensor, touch sensor or electric switch configured to detect the user action to open the drawer.

5. The tool storage system of claim 1, wherein the drawer assembly further includes a drawer handle that allows the drawer to be opened and closed.

6. The tool storage system of claim 1, wherein the sensor configured to detect the user action includes the sensor configured to detect a pulling force applied to the drawer.

7. The tool storage system of claim 6, wherein the drawer assembly further includes a drawer handle movably affixed to the drawer, and the sensor includes an electric switch, and
wherein the drawer handle is movable into contact with the electric switch responsive to the pulling force applied to the drawer handle, and the electric switch is thereby configured to detect the pulling force.

8. The tool storage system of claim 7, the drawer assembly further includes a rotatable shaft by which the drawer handle is movably affixed to the drawer, and the drawer handle is rotatable and thereby movable into contact with the electric switch responsive to the pulling force applied to the drawer handle.

9. The tool storage system of claim 7, wherein the drawer assembly further includes a linearly movable shaft by which the drawer handle is movably affixed to the drawer, and the drawer handle is movable forward and backward and thereby movable into contact with the electric switch responsive to the pulling force applied to the drawer handle.

10. The tool storage system of claim 7, wherein the drawer handle includes a pull member and a contact member that are connected and movable together responsive to the pulling force that is applied to the pull member, and the contact member is movable into contact with the electric switch, and
wherein the drawer includes a drawer front panel by which the drawer handle is movably affixed to the drawer, the pull member and the contact member are located on opposing sides of the drawer front panel, the pull member located outside the drawer, and the contact member is located inside the drawer.

11. The tool storage system of claim 1, wherein the electric lock includes a spring-loaded pin that is compressed inside the electric lock when the electric lock is engaged with the latch, and configured to extend out from the electric lock when the latch is disengaged to push the drawer at least partially open.

12. The tool storage system of claim 1, wherein the tool storage system further comprises a second drawer that is operably coupled to the cabinet, and the processing circuitry is configured to control the electric lock to disengage the latch only when the second drawer is closed.

13. A drawer assembly for a tool storage system that includes a cabinet, the drawer assembly comprising:
a drawer operably coupled to the cabinet to enable the drawer to slidably open and close;
a sensor configured to detect a user action to open the drawer when the drawer assembly is installed in the cabinet; and
an electric lock or a latch of a lock assembly that includes the electric lock and the lock assembly, the electric lock configured to engage the latch when the drawer assembly is installed in the cabinet and the drawer is closed, and disengage the latch to enable the drawer to open,
wherein the sensor and the electric lock are couplable with processing circuitry configured to receive a signal from the sensor responsive to detection of the user action to open the drawer, and control the electric lock to disengage the latch responsive to the signal.

14. The drawer assembly of claim 13, wherein the drawer assembly includes the latch that is affixed to the drawer.

15. The drawer assembly of claim 13, wherein the drawer assembly includes the electric lock that is affixed to the drawer.

16. The drawer assembly of claim 13, wherein the sensor includes an optical sensor, pressure sensor, touch sensor or electric switch configured to detect the user action to open the drawer.

17. The drawer assembly of claim 13, wherein the drawer assembly further includes a drawer handle that allows the drawer to be opened and closed.

18. The drawer assembly of claim 13, wherein the sensor configured to detect the user action includes the sensor configured to detect a pulling force applied to the drawer.

19. The drawer assembly of claim 18, wherein the drawer assembly further includes a drawer handle movably affixed to the drawer, and the sensor includes an electric switch, and
wherein the drawer handle is movable into contact with the electric switch responsive to the pulling force applied to the drawer handle, and the electric switch is thereby configured to detect the pulling force.

20. The drawer assembly of claim 19, wherein the drawer handle includes a pull member and a contact member that are connected and movable together responsive to the pulling force that is applied to the pull member, and the contact member is movable into contact with the electric switch, and
wherein the drawer includes a drawer front panel by which the drawer handle is movably affixed to the drawer, the pull member and the contact member are located on opposing sides of the drawer front panel, the pull member located outside the drawer, and the contact member is located inside the drawer.
